(19) United States
(12) Patent Application Publication
(10) Pub. No.: US 2015/0017422 A1
(43) Pub. Date: Jan. 15, 2015

(54) CONSTRUCTION MATERIAL CONTAINING MICROENCAPSULATED PHASE CHANGE MATERIAL, AND PREPARATION METHOD THEREOF

(71) Applicant: Won-mok Lee, Seoul (KR)

(72) Inventor: Won-mok Lee, Seoul (KR)

(21) Appl. No.: 14/375,790

(22) PCT Filed: Dec. 14, 2012
(86) PCT No.: PCT/KR2012/010907

§ 371 Date: Jul. 30, 2014

(30) Foreign Application Priority Data
Jan. 31, 2012 (KR) 10-2012-0009526

(51) Int. Cl. B32B 37/14; B32B 37/24; C04B 11/00; C04B 7/00; C04B 14/02; B32B 38/00; C04B 14/06

(52) U.S. Cl. CPC B32B 37/144; B32B 38/164; B32B 37/24; C04B 14/06; C04B 7/00; C04B 14/02; C04B 11/00; B32B 2038/0076; B32B 2307/54; B32B 2307/50; B32B 2305/54; B32B 2305/72; B32B 2419/00
USPC 428/323; 156/71

(57) ABSTRACT

Disclosed is a construction & engineering material containing a microencapsulated phase change material, wherein one or more components of construction & engineering materials are selected from a group of construction & engineering materials such as sand, cement, gravel, admixture, gypsum, aggregate, plaster, fiber, and magnesium, and the PCM microcapsules are attached to outer surfaces of the selected one or more components of construction & engineering materials.

### TECHNICAL FIELD

The present invention relates to a construction & engineering material containing a microencapsulated phase change material and a method of producing the same, and more particularly to, a construction & engineering material containing a microencapsulated phase change material and a method of producing the same, wherein the microencapsulated phase change material is attached to outer surfaces of predetermined construction & engineering materials, and two or more construction & engineering materials are mixed which include the construction & engineering materials attached with the microencapsulated phase change material, such that a state in which the microencapsulated phase change materials are uniformly mixed in combined construction & engineering materials used for building a building, road, and bridge may be maintained.

### BACKGROUND ART

In the present invention, the construction & engineering material is generic term for individual constitutional component used for construction engineering work and the representative construction & engineering material is sand, cement, gravel, admixture for enhancing various functions, gypsum, and various plasters, etc. In the present invention, the combined construction & engineering material is generic term for combined materials made by two or more construction & engineering materials described above and representative construction & engineering materials is dry mortar, ready-mixed concrete, concrete, mortar, gypsum board, gypsum mortar, fiber board, magnesium board, and cement board, etc used for construction & engineering works.

Dry mortar, ready-mixed concrete, concrete, or asphalt made with two or more construction & engineering materials as the representative combined construction & engineering materials is used for house construction, road pavement, bridge construction, etc and gypsum board, gypsum mortar, magnesium board, fiber board, etc is or cement board is widely used for construction & engineering works as ready-made combined construction & engineering materials product.

The construction & engineering material such as sand, cement, aggregate, additive, gypsum, plaster, etc can used individually or in combination with two or more components at proper rates as the combined construction & engineering materials product.

Dry mortar, one of representative combined construction & engineering materials is used for plastering work and engineering work as well as for construction of flooring material. Dry mortar is comprised of multiple components construction & engineering material such as sand, cement, sand, and admixtures. It is provided to construction site by sack unit and easy to use by just mixing of water at predetermined ratio.

In construction, by using the combined construction & engineering materials such as the dry mortar, ready-mixed concrete, or concrete, a plurality of construction & engineering materials constituting mortar and concrete are dry-mixed, the plurality of construction & engineering materials are mixed with water, mortar and concrete in slurry are uniformly poured and distributed at a pouring location. Then, the poured mortar and concrete may be obtained enough strength while being dried and cured in a natural state and do not occur a crack.

Nowadays, the world makes an effort to prevent global warming due to Greenhouse Gas (GHG) such as carbon dioxide (CO2) and methane (CH4) emitted due to mancomponent activity.

Therefore, as a global countermeasure, United Nations Framework Convention On Climate Change (UNFCCC) is adapted in 1992, and each country sets a self-countermeasure and policy and has made a continuous effort up to now. After a Kyoto Protocol of 1997 suggested as a specific execution plan of UNFCCC is announced, an international interest about greenhouse gas reduction further increases, and particularly, it is known that an effect of CO2 among greenhouse gases that become a major cause of a climatic change is 55% or more and is much greater than that of other elements and thus greenhouse gas reduction technology according to CO2 reduction is importantly considered.

Therefore, even in the construction & engineering material field, as energy reduction and CO2 reduction methods based on an efficient equipment system, much effort has been performed for development of a construction & engineering material and a construction method and thus many new technologies arrive in a practical use level.

A material and technology according to heat storage among such technology are very effective and may be remarkable technology. Therefore, in a material field, from late 1980s, a research for using a Phase Change Material (hereinafter, PCM), which is an innovative temperature adjustment material that performs a heat storage and temperature adjustment function has been gradually performed, but a level thereof is low yet in South Korea.

Most energy reduction technologies by a PCM are technologies on an exterior element of a structure such as a building exterior material. Most of such technologies have several problems in view of construction and maintenance and have a problem in an economic performance accordingly.

Conventionally, a method of producing dry mortar containing a microencapsulated phase change material (hereinafter, referred to as a “PCM microcapsule”) is disclosed in Korean Patent No. 10-0602717.

In the conventional art, after producing the PCM microcapsule in a powder phase by drying, the PCM microcapsules are mixed with dry mortar and is used.

However, conventionally, when a PCM microcapsule produced in a powder phase is mixed in dry mortar or concrete, during a curing period after being poured, the PCM microcapsule mixed with mortar or concrete moves to an upper layer due to a specific weight difference and is intensively distributed and thus poured floor causes a peeling phenomenon, and compressive strength, attachment strength, and tensile strength are deteriorated, and there was a serious problem that unbalance of a crack and a hydration heat occurs. Particularly, in order to form horizontality with a self-weight of dry mortar and to form a flat bottom surface having excellent durability, in dry mortar for a floor that mixes water of an excess amount, such a phenomenon is very serious.

This is because as in concrete, cement has a density of about 3.15 and sand has a density of about 2.6, but a specific weight of the PCM microcapsules are about 0.8 to 1.0 and thus while curing is performed after pouring, the PCM microcapsule floats to an upper layer and the floated PCM microcapsule forms a layer in an upper portion and thus the foregoing problems cause.

### DETAILED DESCRIPTION OF INVENTION

### Technical Problem

The present invention has been made in view of the above problems, and provides a construction & engineering material containing a microencapsulated phase change material and a method of producing the same that can save energy, reduce a dew condensation phenomenon, and control a hydration heat occurring when curing concrete and in which a PCM microcapsules are moved in an upper layer of mortar or concrete due to a specific weight after being poured and thus uniformly distributed without forming a layer and maintains a mixed state by putting a PCM microcapsule in slurry into at least one construction & engineering material, by selectively putting and moving cement, plaster, or a binder, by enabling they to fully contact and drying them, and by securely attaching the PCM microcapsule to a surface of the construction & engineering material.

The present invention further provides a construction & engineering material containing a microencapsulated phase change material and a method of producing the same that can solve problems that may occur due to a specific weight, when producing a construction board by putting a PCM microcapsule in slurry into at least one raw material of an existing board and by selectively putting and moving gypsum, cement, or a binder, by enabling they to fully contact and dry, and by securely attaching the PCM microcapsule to a selected existing raw material component and by primarily procuring various board raw materials containing a microencapsulated phase change material having a specific weight similar to that of the existing raw material by using the various board raw materials in a producing process of a combined construction & engineering material of various boards and, even when producing a combined construction & engineering material of various boards such as gypsum board, gypsum mortar, magnesium board, and cement board.

### Technical Solution

In accordance with an aspect of the present invention, there is provided a construction & engineering material containing a microencapsulated phase change material, wherein a PCM microcapsules are attached to outer surfaces of one or more construction & engineering materials selected from a group of the construction & engineering materials such as sand, cement, gravel, admixture, gypsum, aggregate, plaster, fiber, and magnesium.

In accordance with another aspect of the present invention, a method of producing a construction & engineering material containing a microencapsulated phase change material includes: putting a PCM microcapsule in slurry into one or more components of the construction & engineering materials selected from the construction & engineering materials such as sand, cement, gravel, admixture, gypsum, aggregate, plaster, fiber, and magnesium; mixing cement or a binder with the at least one component of construction & engineering material and moving and drying the mixed cement or a binder and at least one component of construction & engineering material; and fixing and attaching the PCM microcapsule to an outer surface of the construction & engineering material.

### ADVANTAGEOUS EFFECTS

According to the present invention, by directly attaching and fixing a PCM microcapsule to an outer surface of a construction & engineering material, when pouring and curing a combined construction & engineering material such as mortar, ready-mixed concrete, or concrete produced by mixing a plurality of construction & engineering materials, the PCM microcapsule moved to an upper layer due to a specific weight difference with the PCM microcapsule separated from the construction & engineering material prevents from forming a layer and thus compressive strength, attachment strength, and tensile strength can be prevented from being deteriorated or peeling of the bottom occurring when the PCM microcapsule layer is formed can be prevented and a crack can be prevented, and a thermal effect can be enhanced with uniform distribution of the PCM microcapsule.

Further, when producing a dry material of a light weight such as a gypsum board and gypsum mortar, by attaching and fixing a PCM microcapsule in slurry to at least one material through putting, mixing, and drying, a production problem that may occur due to a specific weight difference when producing such a dry material of a light weight can be solved.

Particularly, in a dry process of performing so as to attach the PCM microcapsule to a construction & engineering material, by using a surfactant used when producing the PCM microcapsule as a polymer binder, a production cost of a construction & engineering material can be remarkably reduced.

### BRIEF DESCRIPTION OF DRAWINGS

FIG. 1 is a cross-sectional view illustrating a construction & engineering material containing a microencapsulated phase change material according to an exemplary embodiment of the present invention.

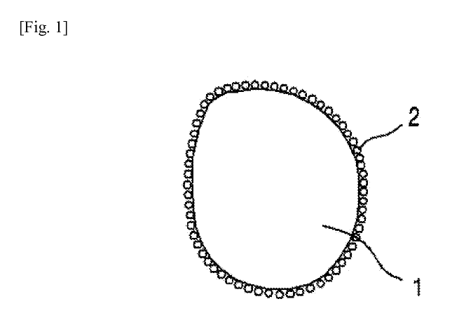

### BEST MODES FOR CARRYING OUT THE INVENTION

By putting a PCM microcapsule 2 in slurry into a construction & engineering material 1 containing a microencapsulated phase change material according to an exemplary embodiment of the present invention selected from at least one of sand, cement, aggregate, admixture used as a characteristic enhancing agent, gypsum, and plaster and mixing them, the construction & engineering material 1 in which the PCM microcapsule 2 is securely attached to a surface of the selected construction & engineering material 1 through drying can be obtained.

In this case, when the selected construction & engineering material 1 is not cement, if the proper quantity of cement or gypsum, which is a representative coupling curing agent for a construction work and a civil engineering work is together mixed, the PCM microcapsule may be more securely attached and fixed to a surface of the construction & engineering material 1. Further, a method of putting a binder may be used, as needed.

According to the present exemplary embodiment, by putting a PCM microcapsule in slurry having solid contents of 1 to 80 wt %, preferably 30 to 60 wt % into sand selected as the construction & engineering material 1 and by mixing, and drying the PCM microcapsule and the sand, sand in which the PCM microcapsules are attached to an outer surface thereof can be obtained.

In this case, an amount of the putted PCM microcapsule in slurry may be properly adjusted according to a use purpose.

A PCM microcapsule in slurry means a mixture of solid and liquid having fluidity, and in the present invention, due to the reason described in the following description, in order to increase adhesive power with a construction & engineering material, it is preferable not to reduce a polymer surfactant used when producing the PCM microcapsule, and in order to enhance a uniform dispersion property and individual adhesive power with a construction & engineering material, the PCM microcapsule should have fluidity. In order to have fluidity, it is preferable that solid contents of the PCM microcapsules are maintained to 60% or less. In order to increase solid contents, after a microcapsules are produced, a processing that dehydrates using a filter press reduces most polymer surfactants and removes liquidity and thus does not correspond to an object of the present invention.

Further, in a dry process performed after mixing a PCM microcapsule in slurry with the construction & engineering material, by maintaining a temperature range of 30° C. to 500° C., the PCM microcapsule can be prevented from being damaged.

The dry is high temperature dry using a drying chamber or low temperature dry that maintains vacuum and may use a dry process of an existing production process such as cement, dry mortar, ready-mixed concrete, or concrete, add an equipment, or attach a PCM microcapsule by drying without a separate additional cost through some deformation.

In this case, even after the mixed construction & engineering material and PCM microcapsule in slurry are put into a drying chamber operating in a temperature range of 30° C. to 500° C. while continuously maintaining a flow state, the mixed construction & engineering material and PCM microcapsule maintain a flow state and thus a selected binder and the mixed PCM microcapsule may be uniformly attached and fixed to an outer surface of the construction & engineering material without agglomerating.

In a dry process, a polymer surfactant essentially used so as to give stability of emulsification when producing the PCM microcapsule in slurry as a polymer binder through dehydration and dry processes may enable the PCM microcapsule to be securely attached and fixed to an outer surface of a construction member. A conventional microcapsule emulsifier may be used as a binder through such a mechanism. As in the conventional art, when individually drying only a PCM microcapsule in slurry, when producing the PCM microcapsule with a powder phase, and when putting the PCM microcapsule into a construction & engineering material, the PCM microcapsules are produced and put as powder of a self specific weight thereof and thus when the PCM microcapsules are mixed with most construction & engineering materials, there is a serious problem that a combined construction & engineering material cannot be produced due to a large specific weight there between, and even when putting the PCM microcapsule in slurry instead of attaching to any one of construction & engineering materials before being cured or in a flow state of a production process of a combined construction & engineering material such as a board, due to a large specific weight difference with most construction & engineering materials, a serious problem occurs that only the PCM microcapsules are separated.

In the present invention, a polymer surfactant used when producing a PCM microcapsule performs a binder function or selectively adds cement, plaster, or binder as a binding agent, and as polymer surfactant securely attaches the PCM microcapsule to an outer surface of one material selected from construction & engineering materials, such as a main material, by making a specific weight of the PCM microcapsule to a state changed to be almost equally to an existing specific weight of a construction & engineering material, which is a main material, a method of producing a combined construction & engineering material in which the PCM microcapsule such as dry mortar, ready-mixed concrete, or gypsum board is uniformly contained is produced, and when using the PCM microcapsule in a slurry state, by using a dry process of an existing construction & engineering material without a dry process of a separate PCM microcapsule, a cost can be reduced.

In more detail, when producing the PCM microcapsule, in order to provide emulsion stabilization of a polymerization process, the PCM microcapsule in slurry may use a polymer emulsifier, having a molecular weight of about 10,000 to 800,000, such as ethylene acrylate copolymer, styrene acryl copolymer, styrene maleic acid copolymer, ethylene maleic acid copolymer, polyvinyl alcohol, and ethylene acrylate copolymer, and the PCM microcapsules are a polymer surfactant having both a hydrophilic portion and a hydrophobic portion, and when producing the microcapsule, the PCM microcapsule may form an aggregate that can simultaneously provide particle stabilization and a polymerization location, and may simultaneously perform an electrostatic stabilization operation, and a surfactant generally known in the art may be selected and used.

Such a polymer surfactant may exhibit strong adhesive power as a polymer binder while being dehydrated, absorbed, or grafted at a surface of sand, cement, aggregate, and admixture, such as a construction & engineering material during a dry process of a PCM microcapsule particle.

Further, as described above, a generally known water-soluble or oil-soluble binder may be added, as needed. A bonding force of a binder bonded as a polymer property is determined by cohesion of the binder and a bonding force between a binder molecule and a chemical agent molecule operating at a bonding interface, and when an adherent molecule and a binder molecule are in a covalent bond state, a strong bonding force is obtained and binding may be formed by second coupling by van der Waales force or a hydrogen bond of an epoxy resin binder.

As a component of such a binder, a generally known binder such as epoxy resin, phenolic resin, poly acetic acid vinyl, polyamide, polyvinyl alcohol, silicon resin, polyurethane, urea resin, melamine resin, polyolefin, and rubber may be selected, and such a binder is not limited thereto.

By mixing two or more construction & engineering materials containing a microencapsulated phase change material produced through such a processing, a combined construction & engineering material such as dry mortar, ready-mixed concrete, concrete, pavement asphalt aggregate, gypsum board, gypsum mortar, magnesium board, fiber board, and cement board may be produced, and a combined construction & engineering material produced by mixing construction & engineering materials is not limited thereto.

A Phase Change Material (PCM) may be represented with a potential heat material or a heat storage material and is a material that absorbs or emits much heat energy (potential heat) while changing from a solid phase to a liquid phase or from a liquid phase to a solid phase in a predetermined temperature range, and there are several components of materials including water, but in the present invention, a random material having such a matter property may be used, and materials in which a melting temperature is about −20 to 90° C. may be selected like paraffin wax and ester and are not limited thereto.

A phase change material that may be used in the present invention includes various organic and inorganic materials. The phase change material is not limited thereto and may include, for example, hydrocarbon (straight-chain or branched alkane or paraffin hydrocarbon), hydrated salt (calcium chloride 6-hydrate, potassium fluoride 4-hydrate, ammonium alum), wax, oil, fatty acid, complex fatty acid ester, first alcohol, aromatic compound, anhydride (stearic acid anhydride), polyhydric alcohol (ethylene glycol, propylene glycol, tetramethylol propane), polymer (polyethylene, polyethylene glycol, polypropylene, polyester, polyacrylate copolymer, polyethylene glycol).

As a wall material of a PCM microcapsule that coats a surface of a phase change material, a random polymer that may be used as a wall material of a microcapsule may be generally used, but is number of element, and at least one polymer selected from a group such as melamine resin, urea resin, acrylic resin, polystyrene, polyurethane, polyamide, poly methyl methacrylate, epoxy, polyethylene, polyester, polyvinyl alcohol, and gelatin may be used.

1. Construction & engineering material containing microencapsulated phase change material, wherein one or more components of construction & engineering materials are selected from a group of construction & engineering materials such as sand, cement, gravel, admixture, additive, gypsum, aggregate, plaster, fiber, and magnesium, and the PCM microcapsules are attached to outer surfaces of the selected one or more components of construction & engineering materials.

2. The construction & engineering material of claim 1, wherein the PCM microcapsules are provided in a slurry state to be uniformly distributed and mixed with the construction & engineering materials and is put into a drying chamber operating in a temperature range of 30° C. to 500° C. to be dried.

3. The construction & engineering material of claim 1, wherein the PCM microcapsules are provided in a slurry state to be uniformly distributed and mixed with the construction & engineering materials, is put into a drying chamber operating in a temperature range of 30° C. to 500° C., and is attached to the outer surfaces of the construction & engineering materials under a circulating condition.

4. The construction & engineering material of claim 1, wherein one or more components of the construction & engineering materials are selected from the group of the construction & engineering materials such as sand, cement, gravel, admixture, additive, gypsum, aggregate, plaster, fiber, and magnesium, and the selected one or more components of construction & engineering materials are mixed by adding cement, gypsum, or binder as binding agent.

5. The construction & engineering material of claim 2, wherein solid contents of the PCM microcapsule slurry range from 1 to 55 wt %.

6. The construction & engineering material of claims 1, wherein the one or more components of the construction & engineering materials are selected from the group of the construction & engineering materials such as sand, cement, gravel, admixture, additive, gypsum, aggregate, plaster, fiber, and magnesium, and the selected one or more components of the construction & engineering materials are used for producing dry mortar in which the PCM microcapsules are attached to one or more outer surfaces of any one of cement, admixture, additive and sand.

7. The construction & engineering material of claim 4, wherein the one or more components of the construction & engineering materials are selected from the group of the construction & engineering materials such as sand, cement, gravel, admixture, additive, gypsum, aggregate, plaster, fiber, and magnesium, the selected one or more components of the construction & engineering materials are used for producing dry mortar in which the PCM microcapsules are attached to one or more outer surfaces of any one of cement, admixture, additive and sand.

8. The construction & engineering material of claim 5, wherein the one or more components of the construction & engineering materials are selected from the group of the construction & engineering materials such as sand, cement, gravel, admixture, additive, gypsum, aggregate, plaster, fiber, and magnesium, and the selected one or more components of the construction & engineering materials are used for producing dry mortar in which the PCM microcapsules are attached to one or more outer surfaces of any one of cement, admixture, additive and sand.

9. The construction & engineering material of claim 1, wherein the one or more components of the construction & engineering materials are selected from the group of the construction & engineering materials such as sand, cement, gravel, admixture, additive, gypsum, aggregate, plaster, fiber, and magnesium, and the selected one or more components of the construction & engineering materials are used for producing ready-mixed concrete or concrete in which the PCM microcapsules are attached to one or more outer surfaces of any one of cement, sand, gravel, admixture, additive and aggregate.

10. The construction & engineering material of claim 4, wherein the one or more components of the construction & engineering materials are selected from the group of the construction & engineering materials such as sand, cement, gravel, admixture, additive, gypsum, aggregate, plaster, fiber, and magnesium, and the selected one or more components of the construction & engineering materials are used for producing ready-mixed concrete or concrete in which the PCM microcapsules are attached to one or more outer surface of any one of cement, sand, gravel, admixture, additive and aggregate.

11. The construction & engineering material of claim 5, wherein the one or more components of the construction & engineering materials are selected from the group of the construction & engineering materials such as sand, cement, gravel, admixture, additive, gypsum, aggregate, plaster, fiber, and magnesium, and the selected one or more components of the construction & engineering materials are used for producing ready-mixed concrete or concrete in which the PCM microcapsules are attached to one or more outer surfaces of any one of cement, sand, gravel, admixture, additive and aggregate.

12. The construction & engineering material of claim 1, wherein the one or more components of the construction & engineering materials selected from the group of the construction & engineering materials such as sand, cement, gravel, admixture, additive, gypsum, aggregate, plaster, fiber, and magnesium, and the selected one or more components of the construction & engineering materials are used for producing a board in which the PCM microcapsules are attached to one or more outer surfaces of any one of gypsum, magnesium, cement, gravel, admixture, additive, aggregate, plaster, and fiber.

13. The construction & engineering material of claim 4, wherein the one or more components of the construction & engineering materials are selected from the group of the construction & engineering materials such as sand, cement, gravel, admixture, additive, gypsum, aggregate, plaster, fiber, and magnesium, and the selected one or more components of the construction & engineering materials are used for producing a board in which the PCM microcapsules are attached to one or more outer surfaces of any one of gypsum, magnesium, cement, gravel, admixture, additive, aggregate, plaster, and fiber.

14. The construction & engineering material of claim 5, wherein the one or more components of the construction & engineering materials are selected from the group of the construction & engineering materials such as sand, cement, gravel, admixture, additive, gypsum, aggregate, plaster, fiber, and magnesium, and the selected one or more components of the construction & engineering materials are used for producing a board in which the PCM microcapsules are attached to one or more outer surface of any one of gypsum, magnesium, cement, gravel, admixture, additive, aggregate, plaster, and fiber.

15. The construction & engineering material of claim 1, wherein the PCM microcapsules are attached to an outer surface of the construction & engineering materials selected from the group of the construction & engineering materials such as sand, cement, gravel, admixture, additive, gypsum, aggregate, plaster, fiber, and magnesium as aggregate mixed with asphalt for road pavement.

16. The construction & engineering material of claim 4, wherein the PCM microcapsules are attached to an outer surface of the construction & engineering material selected from the group of the construction & engineering materials such as sand, cement, gravel, admixture, additive, gypsum, aggregate, plaster, fiber, and magnesium as aggregate mixed with asphalt for road pavement.

17. The construction & engineering material of claim 5, wherein the PCM microcapsules are attached to an outer surface of the construction & engineering material selected from the group of the construction & engineering materials such as sand, cement, gravel, admixture, additive, gypsum, aggregate, plaster, fiber, and magnesium as aggregate mixed with asphalt for road pavement.

18. A method of producing construction & engineering material containing microencapsulated phase change material, the method comprising:
putting the PCM microcapsule in slurry into one or more components of construction & engineering materials selected from a group of the construction & engineering materials such as sand, cement, gravel, admixture, additive, gypsum, aggregate, plaster, fiber, and magnesium;
mixing cement or binder with the one or more components of the construction & engineering materials, and then drying the mixed one or more components of construction & engineering materials under a circulating condition; and
attaching the PCM microcapsules to outer surfaces of one or more components of the construction & engineering materials.
